(19) United States
(12) Patent Application Publication
(10) Pub. No.: US 2005/0253837 A1
(43) Pub. Date: Nov. 17, 2005

(54) Matrix display device

(75) Inventors: Roy Van Dijk, Eindhoven (NL); Siebe Tjerk De Zwart, Eindhoven (NL); Ramon Pascal Van Gorkom, Eindhoven (NL); Hendrikus Bernardus Van Den Brink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/520,200

(22) PCT Filed: Jun. 16, 2003
(86) PCT No.: PCT/IB03/02401

§ 371 Date: Jan. 4, 2005

(30) Foreign Application Priority Data
Jul. 9, 2002 (EP) 02077766.0

(51) Int. Cl. G09G 5/00

(52) U.S. Cl. 345/214

(57) ABSTRACT

A matrix display device comprises cavities (20) having walls at least one of which is covered with a material (24) having a secondary emission coefficient of more than unity. The cavities form a planar arrangement substantially parallel to the display screen which has a phosphor display screen. The cavities are provided with electrodes (21, 215, 217, 5 22, 225, 228) and the display device has a circuit for supplying an oscillating AC voltage (Vr, VRF) to said electrodes (21, 215, 217, 22, 225, 228) for generating electrons within the cavities by secondary emission. The cavities (20) have apertures (25) facing the screen (41), and the display device has a circuit for selectively letting electrons generated within the cavities pass said apertures and accelerating electrons having passed said apertures to the phosphor display screen.

### FIELD OF THE INVENTION

The invention relates to a matrix display device, having a flat display screen, comprising pixels arranged in rows and columns and a system having electrodes and an addressing circuit for addressing the pixels.

Many such matrix displays are known and range from plasma display panels (PDPs), plasma-addressed liquid crystal panels (PALCs), liquid crystal displays (LCDs), to Polymer LEDs (PLEDs), to Electroluminescent (EL) displays to flat CRT devices in which electrons are generated, for instance by line cathodes. Such displays are used e.g., but not exclusively, for personal computers, television sets and so forth. Within the concept of the invention pixels are to be understood to be any addressable image elements.

### BACKGROUND OF THE INVENTION

A matrix display device comprises a first set of elements (rows) extending in a first direction, usually called the row direction, and a second set of elements (columns) extending in a second direction, usually called the column direction, intersecting the first set of elements, each intersection defining a pixel (dot) or set of pixels. Applying appropriate voltages to these elements or parts of or attached to or provided on said elements (such as electrodes) produces a physical effect or chemical effect in or near the intersection, which directly or indirectly leads to generation of visible light on a display screen at a pixel spot usually near the intersection.

A matrix display device further comprises means for receiving an information signal comprising information to be sent to the first and second elements for generating light at specified times at the pixel spots to provide an image on the display screen.

Although the known matrix display devices find ever more use, for many applications the known devices show weaknesses. Matrix display devices based on LCD effects have intrinsically relatively low luminance (light output) and relatively small viewing angles. The display devices in which an element is switched between two chemical states is usually relatively slow and aging forms a problem. Matrix display devices in which use is made of (line) cathodes have the problem that different cathodes, even at the same voltages, send out differing amounts of electrons thus causing, even with the same voltage settings, considerable differences between luminance values of pixels, to which luminance differences the human eye, even for small differences, is very sensitive. Counteracting such negative effects usually requires measuring devices to be built in the device and fast and sophisticated feedback loops to correct these effects. Differences in aging effects between the cathodes also have a negative influence on the image. Thermal drift due to a slow warming up of the device or parts of the device also causes a reduction of the image quality.

### SUMMARY OF THE INVENTION

The present invention aims to provide an alternative type of matrix displays enabling one or more of the above mentioned problems to be reduced.

To this end the matrix display device is characterized in that the matrix display device comprises cavities having walls at least one of which is covered with a material having a secondary emission coefficient of more than unity, the cavities forming a planar arrangement substantially parallel to the display screen, the display screen being a phosphor display screen, the cavities being provided with electrodes and a circuit for supplying an oscillating AC voltage to said electrodes for generating electrons within the cavities by secondary electron emission, the cavities having apertures facing the screen, the display device having a circuit for selectively letting electrons generated within the cavities pass said apertures and accelerating electrons having passed said apertures to the phosphor display screen.

High efficiency and a large viewing angle are obtained when a phosphor display screen is used. Supplying an oscillating (usually RF frequency) AC voltage generates an electron cloud in the cavities by multiplication due to secondary electron emission. The intensity of said cloud shows as the inventors have seen, probably because the cloud is in saturation, little variation between cavities or in time. Thus variations in the amount of electrons drawn from the cavities are relatively small, reducing problems due to variation in intensity. Furthermore detrimental thermal effects are much smaller than when thermionic cathodes are used. Whereas when cathodes for generating electrons are used heat generation is localized (the cathodes form “hot spots”) and also differs from one cathode to the next, heat generation in the device in accordance with the invention heat generation is generally smaller and evenly distributed over the planar arrangement of cavities, leading to a more evenly distributed heat generation which heat is also more easily carried off, if needed. This strongly reduces the occurrence of differences in temperature and thereby also of thermal drift.

It is observed that generation of secondary electrons by a RF field is a known effect. The effect causes problems, sometimes severe problems, in such devices as klystrons and standing wave tubes. In U.S. Pat. No. 3,201,640 an electron gun for a CRT is described in which a set of concave electrodes are used between which an oscillating electrical field is provided. However, in this known device the object is to provide a single pencil-like focused high-intensity electron beam in a standard cathode ray tube. In such a device the heat generation is still localized, large thermal differences and thermal drift still occur and, furthermore, the known electron gun cannot be used, nor is suitable for or intended for use in a matrix display device.

Preferably the arrangement of cavities comprises elongated cavities extending in a direction parallel to a row or a column, the elongated cavities being separated by a wall. Such an arrangement, compared with arrangements where a separate cavity is provided for each pixel, offers a simplification of the design. This also lowers the RF frequency which is advantageous since in general the lower the RF frequency the simpler the electronics may be.

### BRIEF DESCRIPTION OF THE DRAWINGS

These and other aspects of the invention are apparent from and will be elucidated with reference to the embodiment(s) described hereinafter with reference to the accompanying drawings.

In the drawings:

FIG. 1 schematically shows a matrix display device;

FIGS. 2 to 4 show schematically the basic working principle of the matrix display device in accordance with the invention.

FIGS. 5A and 5B show details of an exemplary embodiment of a matrix display device in accordance with the invention.

FIG. 6 illustrates a driving scheme for the device shown in FIGS. 5A and 5B.

FIGS. 7 to 13 illustrate various embodiments of the display device in accordance with the invention.

The Figures are not drawn to scale. Generally, like components are denoted by like reference numerals in the Figures.

### DETAILED DESCRIPTION OF PREFERRED EMBODIMENTS

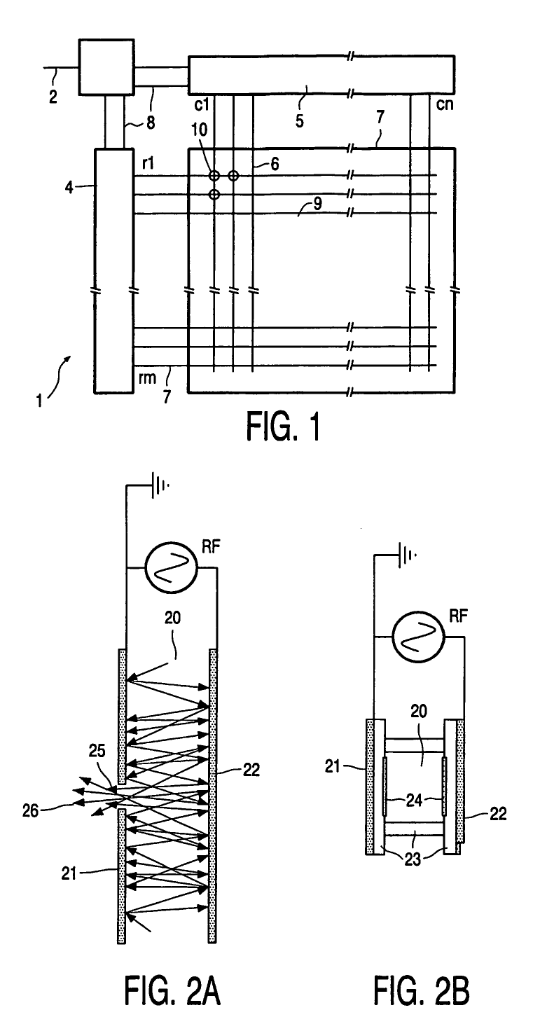

FIG. 1 shows schematically a highly simplified electric equivalent of a matrix display device 1. It comprises a number of row elements 7 and column elements 6 intersecting at a matrix of intersections 10. The row elements r1 to rm can be activated by means of a row driver 4, while the column electrodes c1 to cn are provided with data via a column driver 5. To this end, incoming data 2 can be first processed, if necessary, in a processor 3. Mutual synchronization between the row driver 4 and the data column driver 5 may take place.

Signals from the row driver 4 and the column driver 5 selectively activate an intersection 10. Usually a column element 6 comprises an electrode which acquires such a voltage with respect to an electrode of a row element 7 that the intersection is activated and thereby a pixel on a display screen associated with the relevant intersection is activated (or deactivated, but in any way a visible effect is generated in the pixel). This Figure shows in a very simplified schematic manner the basic design of many matrix display elements. There are electrodes (of elements 6, 7) to which voltages can be supplied selectively by means of a driving circuit 4, 5. When the proper voltages are supplied at an intersection of a column and a row element, some physical or chemical effect is generated, which effect directly or indirectly produces light at a pixel element associated with said intersection or changes the physical or chemical state of an element at or near the intersection, which produces a visible effect. Sequential or simultaneous activation of the intersections and thereby of the pixels on a display screen is used to produce a full image. This can be done line-by-line and in various driving schemes, to which driving schemes the invention is not restricted, unless and in so far as such driving schemes are associated with preferred embodiments of the matrix display device in accordance with the invention.

Many such matrix displays are known and range from plasma display panels (PDPs), plasma-addressed liquid crystal panels (PALCs), liquid crystal displays (LCDs), to Polymer LEDs (PLEDs), to Electroluminescent (EL) displays to flat CRT devices in which electrons are generated, for instance by line cathodes. Such displays are used, but not exclusively for personal computers, television sets and so forth. Within the concept of the invention pixels are to be understood to be any addressable image elements, giving a visible image.

Although the known matrix display devices find ever more use for many applications the known devices show weaknesses. Matrix display devices based on LCD effects have intrinsically relatively low luminance (light output) and relatively small viewing angles. The display devices in which an element is switched between two chemical states is usually relatively slow and aging forms a problem. Matrix display devices in which use is made of (line cathodes) have the problem that different cathodes, even at the same voltages, send out different amounts of electrons thus causing, even with the same settings, differences between luminance values of pixels, to which luminance differences the human eye, even for small differences, is very sensitive. Counteracting such negative effects usually requires measuring devices to be built in the device and fast and extensive feedback loops to correct these effects. Difference in aging effects between the cathodes also has a negative influence on the image.

FIG. 2 (in which A shows only electrical elements, whereas B shows also some physical elements) illustrates schematically the basic working principle of the matrix display device in accordance with the invention. In a cavity, in this embodiment an elongated element 20, an electron generating mechanism is provided by supplying an oscillating (usually RF) voltage between two electrodes 21, 22 in vacuum within at or near the elongated element. Supplying the oscillating voltages produces an oscillating field within the elongated element. At least one of the internal sides of the walls 23 (which could be made of glass in exemplary embodiments) of the cavity 20 is provided with a material 24 (for instance a layer of or comprising an Al—Mg compound) that has a secondary emission coefficient higher than unity. The feature that a wall is provided with said material includes, but is not restricted to, embodiments in which a layer is provided on the wall or in which a material is mixed in the wall material, or in which the wall material itself has said property.

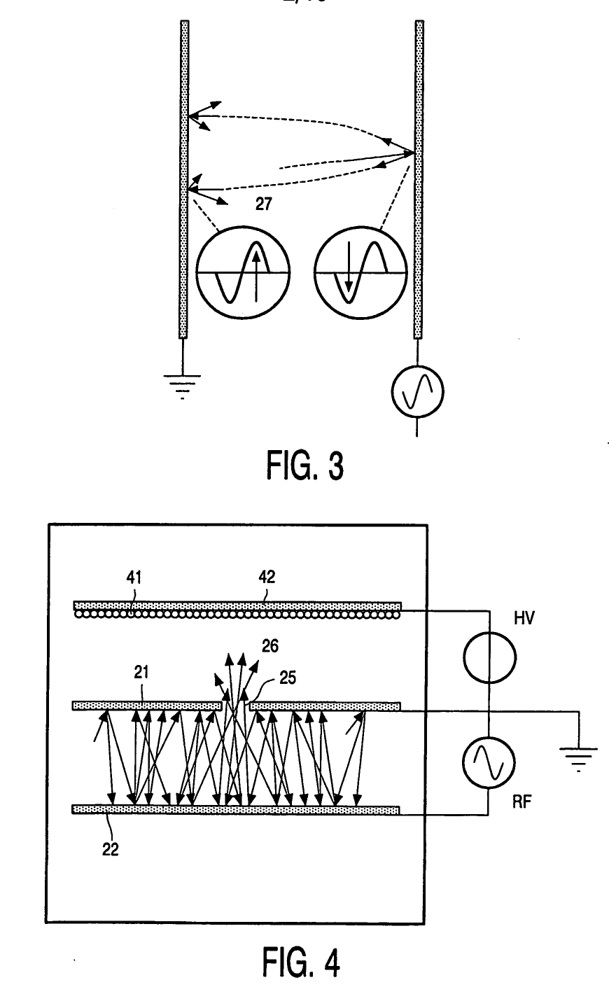

An “initial” electron (cosmic radiation or loosely bound at the electrode surface or supplied by other means to start up the process) 26 (see FIG. 3.) is accelerated by the applied field within the cavity, hits a wall with a material that has a secondary emission coefficient higher than unity and generates secondary electrons. If the field is reversed these secondary electrons are in turn accelerated and hit an opposing wall, generating secondary electrons again. If the average impact energy of the electrons is sufficiently large (>E1, where E1 is the energy for which the secondary emission coefficient exceeds unity) the secondary emission coefficient δ exceeds unity and multiplication occurs. This way, starting from one electron, an electron cloud can be generated bouncing between the two electrodes. The impact energy is inter alia determined by the RF amplitude, the charge density and the length of the cavities. The RF frequency is matched with the flight time of the electrons between the plates, which in turn depends on the RF amplitude. The electrode material is preferably a good secondary emitter in order to keep the RF amplitude and the frequency low. In embodiments an Al—Mg compound is used. If desired, one of the electrode surfaces may be covered by a dielectric layer (coated with e.g. MgO). Such layers can be used to control the (bouncing) current.

It is remarked that the electron cloud is produced by repeated secondary electron emission for which purpose at least a wall of the cavity is provided with a material having a secondary emission coefficient higher than unity. This constitutes the major electron generation process driving the production of the electron cloud. As far as any gas present within the cavity is concerned, the gas pressure is preferably so low that the average distance an electron can travel before interaction with a gas molecule is at least as large, preferably at least twice as large and most preferably five times or more as large as the average distance an electron travels between walls. At higher pressure the gas absorbs much of the generated electrons. Although the gas pressure is thus low, the major process being a vacuum discharge process, the major electron generation being caused by electrons hitting the wall and generating secondary electrons, which process runs best in vacuum, some residual gas may be present, due to inevitable residual gas production, but in some preferred embodiment a minute trace of gas is even beneficial to the production of the “initial electrons” (see above) to start the secondary electron multiplication cascade.

Part of the generated electrons pass and are preferably extracted through an aperture 27 in one of the walls of the cavity, with (in preferred embodiments) or without the aid of a additional extraction field forming an electron beam 26. For each intersection a cavity can be provided, however, in preferred embodiments, the arrangement of cavities comprises elongated elements (as shown in this and further Figures), extending parallel to the rows or columns. Such “pipe-like” cavities simplify the design. In this Figure and further Figures the cavities extend in the row direction. However, although not shown, elongated cavities may also extend in the column direction.

The electrons in beam 26 are accelerated towards and onto a phosphor screen 41 (FIG. 4) on a display screen 40, impinge on the phosphors exiting the phosphors, and thereby causing generation of light. The typical values for generating electron by means of an RF field for a distance d between the plates of 1 cm would be a peak-to-peak voltages of the order of 100 Volts, a frequency of the order of 100 MHz, scaling with 1/d, a vacuum current of 1-10 A/m², scaling with 1/d, and a power consumption of about 35 W/A (independent of d). The electrons are generated within an evacuated envelope. In FIG. 4 the electrons simply pass the aperture and are accelerated towards the screen. In a preferred embodiment, however, extraction electrodes to actively extract the electrons from the aperture may be provided.

Use of a phosphor screen enables a bright image with a large maximum viewing angle to be obtained. The power dissipation within the evacuated envelope is distributed over the entire screen. There are no hot spots leading to problems. The inventors have further found that variation between cavities and aging effects are relatively small effects in comparison with such effects in other known devices. This is probably due to the fact that a saturated electron cloud is made.

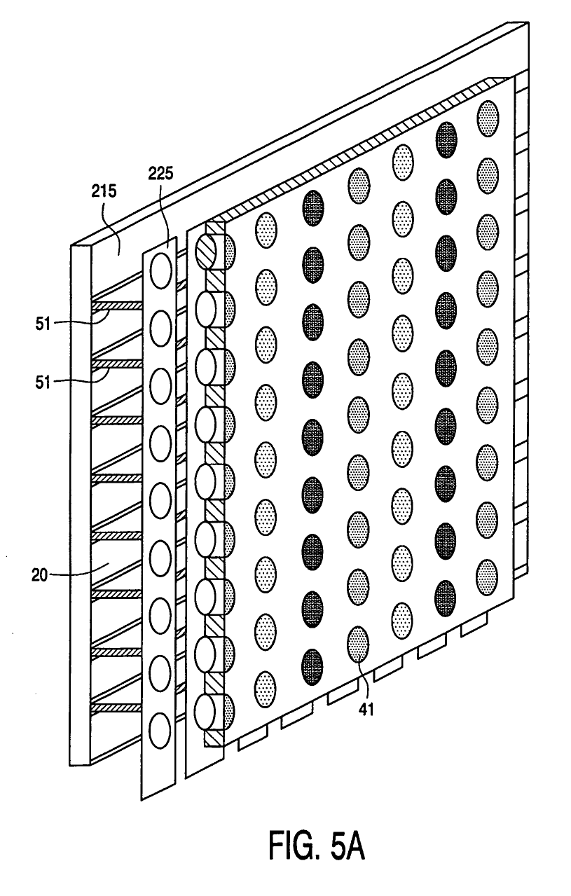

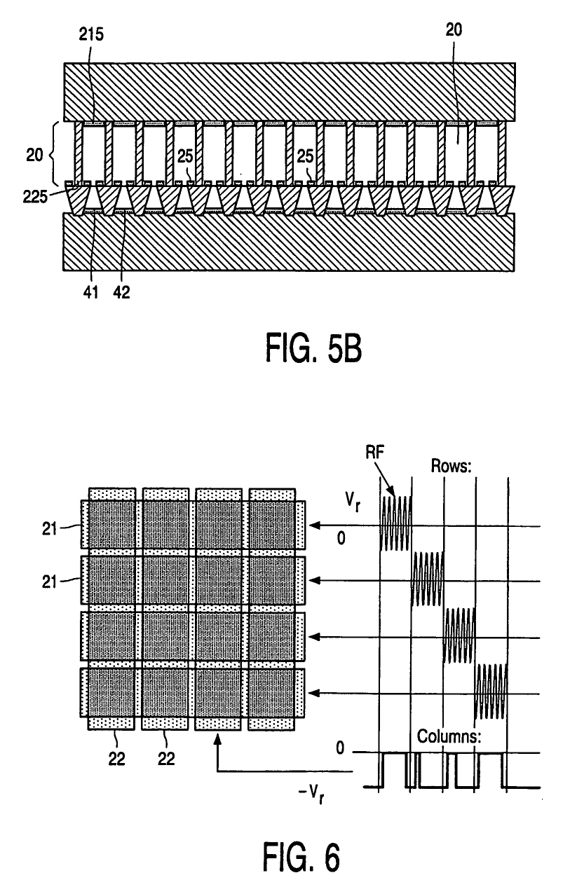

FIGS. 5A and 5B show details of an exemplary embodiment of a matrix display device in accordance with the invention. In said FIGS. 5A and 5B, a display is shown comprising cavities 20, that have first electrodes 215 in a horizontal direction (rows) and second electrodes 225 in a vertical direction (columns). Each elongated element has two side walls 51. At the intersection of the rows and columns electron generation by secondary emission is applied in accordance with the general principle set out above to switch pixels on. In this embodiment the cavities 20 therefore form an arrangement of cavities elongated in a first direction, each cavity comprising a first electrode 215 extending in said direction, the arrangement of cavities being provided with second electrodes 225 extending perpendicularly to the first electrodes, and in operation an oscillation AC voltage is selectively provided between one of the first and one of the second electrodes. There are some possible driving schemes to be used to drive such a display.

FIG. 6 illustrates one driving scheme.

In this embodiment a RF signal with a peak-to-peak voltage Vᵣ is applied to one row. When a column is grounded, the amplitude of the RF exceeds a certain threshold and starts generating electrons by multiplication. A fraction (dependent on the size of the hole) is transmitted through the aperture (see FIG. 5B) in the column and is accelerated to a phosphor screen that is at a high voltage V_{HV} (see FIG. 4). Pixels that are switched off have a high negative voltage >−Vᵣ) on the corresponding columns, thus they are repelling the electrons and the multiplication process is stopped. The rows that are not at a RF voltage could be grounded in the case where there are spacers in between the rows. These are the preferred signals to the rows and columns with the least power dissipation and EMC. Preferably an ITO layer 42 is provided in between the phosphor layer 41 and the display plate 40. The ITO works as an EMC screen reducing Electromagnetic Interference.

Yet a different driving scheme is:

A RF voltage Vᵣ is placed on a row, and another RF voltage with opposite phase is switch on the columns (−Vᵣ), when the pixel of the row intersecting that column needs to generate light. Other columns have a high negative voltage on them (>−Vᵣ), so no electrons can pass and the energy of the electrons hitting the plates is lower than E. Thus for pixels that are switched on the RF peak-to-peak Voltage is 2Vₚ+2Vᵣ. These pixels generate light, whereas for the other pixels no light is generated. Since each pixel generates light only when a RF voltage of opposite sign is applied to the columns, the time during which light is generated in each time slot can be regulated, and thereby the luminance of the pixel can be regulated.

Many more variations both in physical design and in driving scheme are possible.

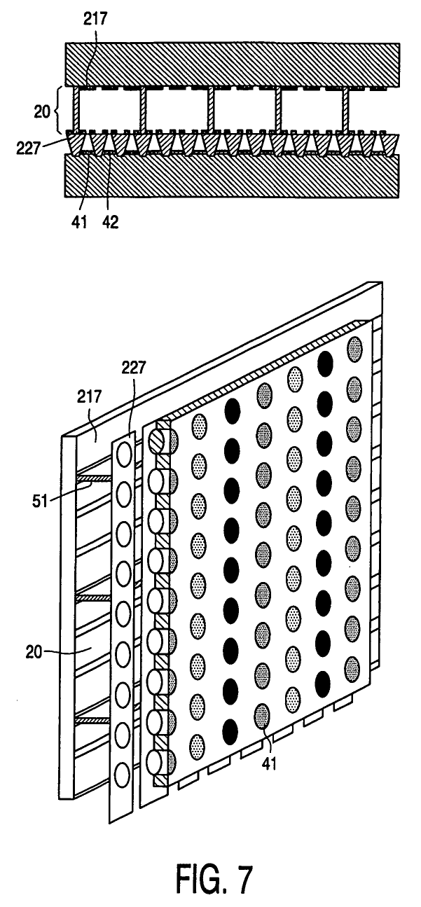

In FIG. 7, a design similar to the one shown in FIGS. 5A and 5B is illustrated with the difference that there are spacers in between every nth and (n+1)th row with n>1, i.e. each cavity 20 comprises more than one row electrode 217. The depth of the cavities 20 depends on the frequency of the voltage source that is convenient to drive such a panel. If a frequency of about 100 MHz is used, a depth of about 1 cm is required. When making a display with such a depth and a line width of the order of 1 mm, the wall can play an important role in whether electron generation is still feasible. It is preferred to make the height of the cavities 20 in about the order of depth of about 1 cm, thus containing several rows. In an extreme example the number of spacers could even be reduced to a spacer on each side of the display. Driving of this display is similar as discussed earlier provided that respect that the rows that are in the same elongated element 20 (not separated by spacers) are preferably at a positive voltage larger than the column voltages. This will prevent that the pixels that are not switched on will receive electrons and thus will emit light too or at least reduce such effects. The advantage of the so far illustrated designs is that the display structure is simpler, for row electrodes, column electrodes and ITO high-voltage screen.

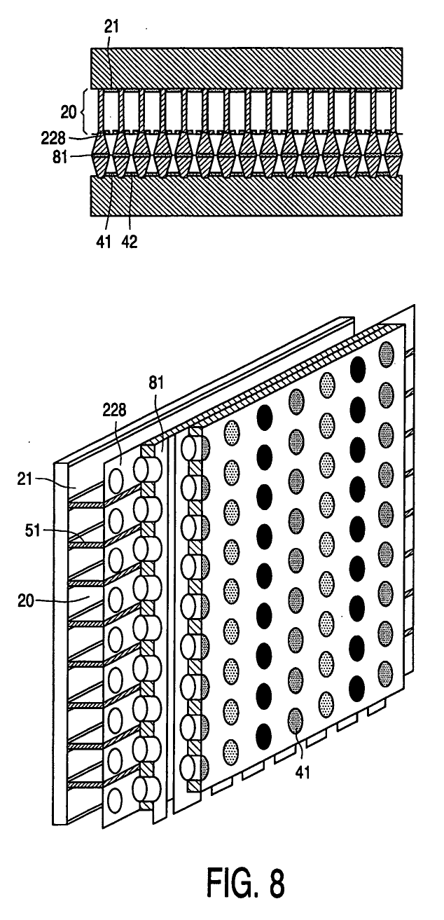

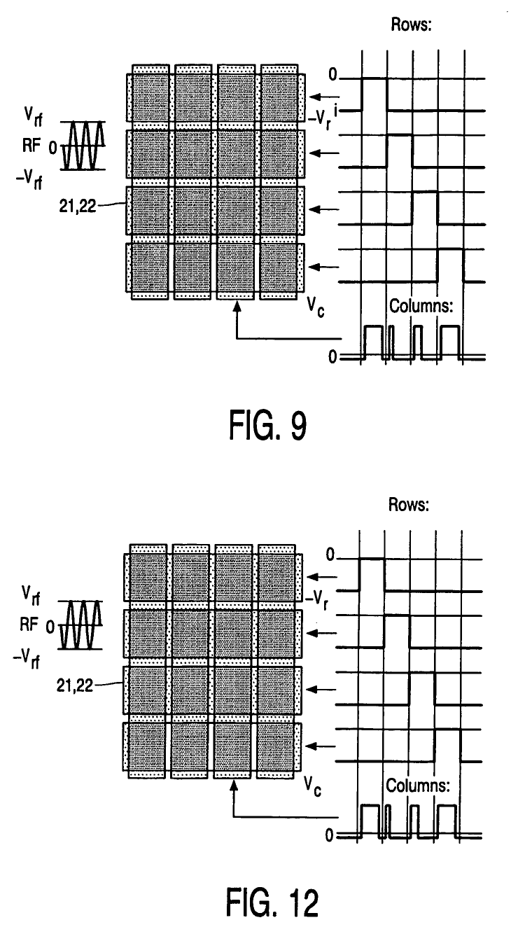

A different design in shown in FIG. 8 in which entire lines generate multiple secondary electrons. This has the advantage that it is not necessary that the multiplication process is switched on and off for each pixel. Each elongated cavity 20 now has two row electrodes 21 and 228 (thus in parallel to each other) in between these two rows electrodes a RF signal is applied. The RF cavities (formed by or in the cavities or part of said elements) are activated line by line. At the phosphor screen side the rows have holes from which electrons can be extracted. To this end column electrodes 81 are provided at or near the apertures through which the electrons may be extracted. The pixel selection is done with proper selection voltages on the columns as shown in FIG. 9. The signals for the RF, rows and columns can be chosen similarly to previously discussed. Several further possibilities are given hereinbelow:

It is possible to apply a RF signal having a peak-to-peak voltage Vᵣ to row conductor 22 with row conductor 21 connected to ground even as the row conductors are not selected. Most electrons hit the grid row conductor 22 when the row voltage is at Vᵣ. When a column electrode 81 is set to a voltage smaller than Vᵣ and preferably smaller than −Vᵣ, the electrons are repelled from the column grid, thus the pixel is switched off. When the column is set to a voltage larger than Vᵣ, the electrons can enter through the column grid, and be accelerated to the phosphor 41, thus the intersection of row and columns is active and the pixel is switched on, i.e. on the phosphor screen the pixel lights up. In this situation the RF voltage is nicely shielded by both the cavity conductor that is at DC and the ITO phosphor screen, thus a very effective EMC protection is provided.

It is also possible to apply a RF signal having a peak-to-peak voltage Vᵣ to row conductor 21 with row conductor 22 and the other row conductors that are not selected connected to ground (or at a low DC voltage). Thus the RF row signal is now on the opposite row conductor compared to the previous situation. The row conductors 21 that are switched off are grounded even as the corresponding row conductors 22 (or these rows are at a low negative voltage, thereby reducing the chance that the electrons can pass through the row grid). When a column electrode 81 is set to a voltage smaller than the row voltage Vᵣ, the electrons are repelled from the column grid, thus the pixel is switched off. When the column electrode 81 is set to a voltage larger than the row voltage Vᵣ, the electrons can enter through the aperture in or near the column electrode, and be accelerated to the phosphor screen 41, thus the pixel is switched on. Due to the fact that the RF voltage is on the back side, additional EMC shielding is preferably provided to reduce EMC radiation.

A RF voltage of ½−V_{rf} is placed on a row electrode 21 (indicated with the row going low), and another RF voltage of −½−V_{rf} thus with opposite phase is placed on the cavity conductor, thus that particular row is switched on. The electrons can pass through the row grid when the RF voltage on the row is Vᵣ. The column selection must be done with a voltage larger than Vᵣ to switch a pixel on and smaller than Vᵣ to switch a pixel off. The advantage of driving a pixel by supplying two electrodes with RF voltages of opposite phase is that the stray electromagnetic fields caused by the application of said opposite phase fields at least partially cancel each other, reducing EMC and electromagnetic interference. Also, the peak-to-peak voltage of each of these signals is reduced (from 2V_{rf} to V_{rf}) which is advantageous from a point of view of electronics and power dissipation.

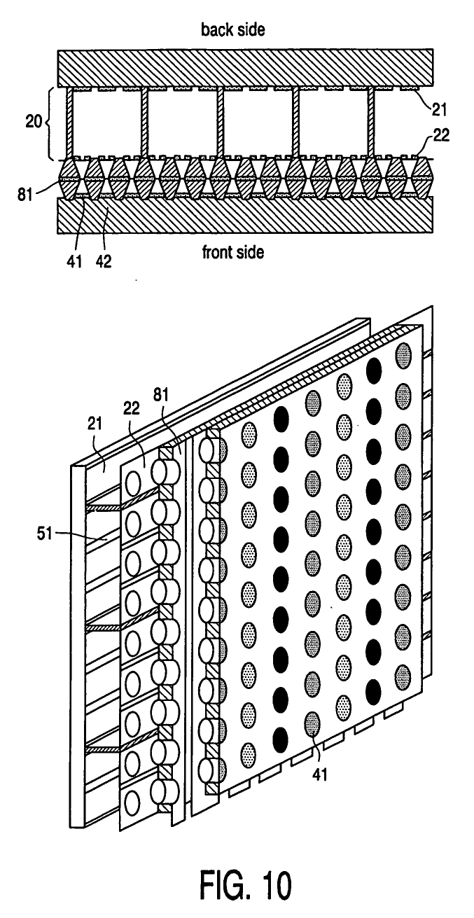

FIG. 10 shows yet a further embodiment of a display device in accordance with the invention, which can be seen as a combination of the embodiments of FIGS. 8 and 9 (row-by-row creation of electrons and separate column extraction) and FIG. 7, i.e. more rows per RF cavity. In FIG. 10, the situation is given when there are more rows within one RF cavity. In this display it must be prevented that more rows in the same RF cavity 20 will be selected. In embodiments this is done by setting those rows to a negative voltage (<−Vᵣ), thereby preventing the electrons to pass through these rows. The electrode 21 could be made as one wide electrode. The rest is similar as explained previously. The advantage is that a RF voltage is present per row and therefore also the multiplication process must start. Therefore, enough free electrons are present to start. When some apertures are present between previous rows or cavities, the row at a time scanning could be rippling from top to bottom. At the far top row, the process could be started or helped with another electron source, for instance a very small thermal emitter. It is remarked that such emitter is only needed for start-up of the multiplication process, it does not provide the electron which hits the phosphor screen. Therefore such a start-up emitter does not need much power. Since the entire row should be switched on, only somewhere in that row the multiplication need to be present, and it will expand in horizontal direction until the entire row is switched on.

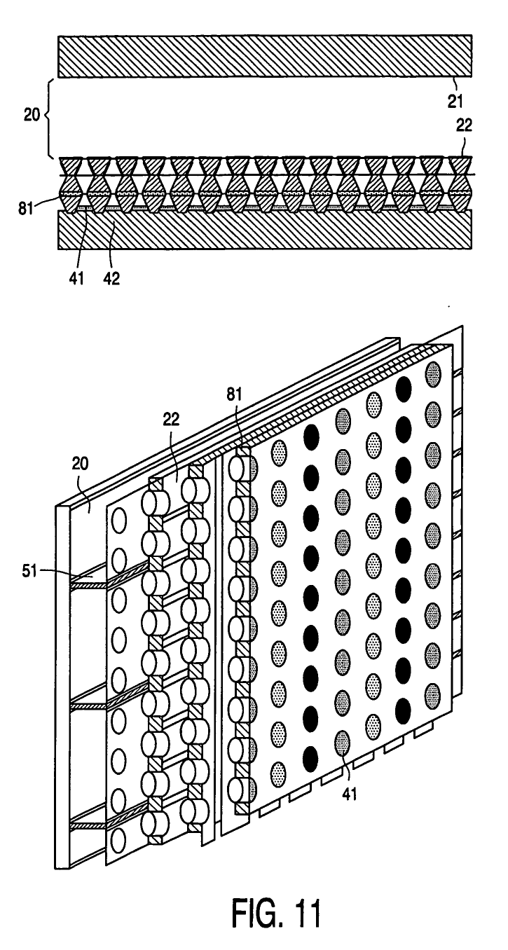

Yet a further embodiment is shown in FIG. 11, the driving scheme of which embodiment is schematically shown in FIG. 12. In this embodiment secondary electron generation takes place in large RF cavities 20 (several rows wide) as shown in FIG. 11. On one side of the cavity electrodes an electrode grid is present comprising a row selection electrode 22 and a column selection electrode structure 81 from which row and column selection of electrons can be done. The extracted electrons are accelerated to a phosphor screen. In this embodiment the secondary electron generation is done in separate cavities 20 that run parallel to the row conductors 22. One such cavity provides more than one row with secondary electrons. With separate row and column selection signals the pixels could be selected that can accelerate the electrons to the phosphor screen thereby emitting light. The RF in the cavity has voltages between −V_{rf} and V_{rf} as shown in FIG. 12. When the cavity electrode closest to the row grid electrode is at V_{rf}, the electrons can pass through the grid when the row voltage Vᵣ is larger or equal to V_{RF}. To block the electrons the row voltage must be smaller than V_{RF}. The column selection can be switched with voltages larger than Vᵣ to switch a pixel in a conduction row on. To block the electrons the column voltage must be smaller than Vᵣ. The RF cavity can be as large as the entire display with spacers at the edges.

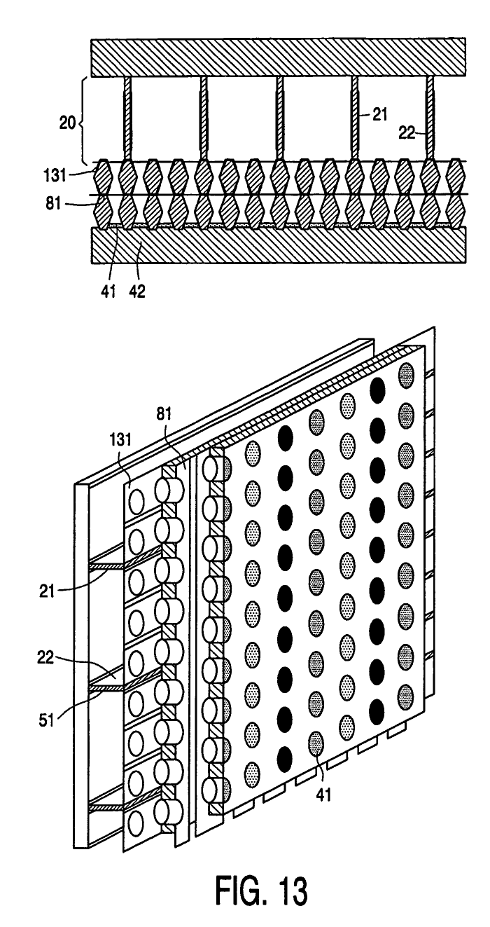

Finally, as a further embodiment of a matrix display device in accordance with the invention, in FIG. 13 a display with large transposed cavity RF electron generation and separate row and column selections is shown

This embodiment is quite similar to the previous ones, but the electron generation takes place perpendicular to the electron generation as is shown in FIG. 13. The electron generation is also done in RF cavities 20 that are one row wide and overlap several rows. In the extreme case only one cavity is present and electron generation is done for the entire display. On one side of the cavity electrodes a grid arrangement is present having row selection electrodes 131 and column selection electrodes 81 by means of which row and column selection of electrons can be done, the extracted electron being accelerated to a phosphor screen 41. The driving signals for this embodiment are almost similar to the signals as given hereinbefore and shown in FIG. 12. Care should be taken that a correct row extraction signal is provided to prevent the row signal to interfere too much with the cavity electric field. The advantage of this structure is that the depth of the display is hardly dependent on the size of the cavities. The size of the cavity can be chosen to match a preferred frequency. A disadvantage may be formed by the fact that non-uniformities can be introduced due to dependencies of the distance of the row to the cavity electrodes.

In sum the invention can be described by:

A matrix display device comprising cavities (20) that have walls of which at least one is covered with a material (24) having a secondary emission coefficient of more than unity. The cavities form a planar arrangement substantially parallel to the display screen which is a phosphor display screen. The cavities are provided with electrodes (21, 215, 217, 22, 225, 228) and the display device has a circuit for supplying an oscillating AC voltage (Vᵣ, V_{RF}) to said electrodes (21, 215, 217, 22, 225, 228) for generating electrons within the cavities by secondary emission. The cavities (20) have apertures (25) facing the screen (41), and the display device has a circuit for selectively letting electrons generated within the cavities pass said apertures and accelerate electrons having passed said apertures to the phosphor display screen.

While the invention has been described in connection with preferred embodiments, it will be understood that modifications thereof within the principles outlined above will be evident to those skilled in the art, and thus the invention is not limited to the preferred embodiments but is intended to encompass such modifications. Modifications include inter alia any and each combination of above-described features and characteristics even if not explicitly described in the claims. Any reference signs do not limit the scope of the claims. The word “comprising” does not exclude the presence of other elements than those listed in a claim. Use of the word “a” or “an” preceding an element does not exclude the presence of a plurality of such elements.

It is for instance possible to interchange rows and columns.

1. Matrix display device, having a flat display screen (41), comprising pixels arranged in rows and columns and a system having electrodes and an addressing circuit for addressing the pixels, characterized in that the matrix display device comprises cavities (20) having walls at least one of which is covered with a material (24) having a secondary emission coefficient of more than unity, the cavities forming a planar arrangement substantially parallel to the display screen, the display screen being a phosphor display screen, the cavities being provided with electrodes (21, 215, 217, 22, 225, 228) and the display device having a circuit for supplying an oscillating AC voltage (Vᵣ, V_{RF}) to said electrodes (21, 215, 217, 22, 225, 228) for generating electrons within the cavities, the cavities (20) having apertures (25) facing the screen (41), the display device having a circuit for selectively letting electrons generated within the cavities pass said apertures and accelerating electrons having passed said apertures to the phosphor display screen.

2. Matrix display device as claimed in claim 1, characterized in that the arrangement of cavities comprises elongated cavities (20) extending in a direction parallel to a row or a column, the elongated cavities being separated by a wall (51).

3. Matrix display device as claimed in claim 2, characterized in that the cavities (20) form an arrangement of cavities elongated in a first direction, each cavity comprising a first electrode (215, 217) extending in said direction, the arrangement of cavities being provided with second electrodes (225) extending perpendicularly to the first electrodes, and in operation an oscillation AC voltage is selectively provided between at least one of the first (215, 217) and at least one of the second electrodes (225).

4. Matrix display device as claimed in claim 2, characterized in that an elongated cavity comprises two electrodes (21, 228) extending in parallel in between which in operation an oscillating AC Voltage is applied.

5. Matrix display device as claimed in claim 3, characterized in that each cavity comprises more than one of the first electrodes (217) or of the two electrodes (21, 228).

6. Matrix display device as claimed in claim 1, characterized in that the matrix display device comprises a grid arrangement having row selection electrodes (131) and column selection electrodes (81) for row and column selection of electrons.

7. Method for driving a matrix display device as claimed in claim 1 wherein for electron cloud generation within a cavity RF voltages of opposite phase are supplied to a first and second electrode within the cavity.
